(19) United States
(12) Patent Application Publication
(10) Pub. No.: US 2009/0282174 A1
(43) Pub. Date: Nov. 12, 2009

(54) STATUS SIGNAL DISPLAYING SYSTEM

(75) Inventors: Chao-Chung Wu, Taipei (TW); Chien-Chin Wang, Taipei (TW); Chien-Shien Lin, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASUSTEK COMPUTER INC., Taipei (TW)

(21) Appl. No.: 12/425,779

(22) Filed: Apr. 17, 2009

(30) Foreign Application Priority Data
May 9, 2008 (TW) 097117250

(51) Int. Cl. G06F 3/00; G06F 13/00

(52) U.S. Cl. 710/19; 710/300

(57) ABSTRACT

A status signal displaying system includes a motherboard, a micro-controller and a display device. The motherboard includes a central processing unit and a plurality of status signal generating circuits for generating status signals. The micro-controller is electrically connected to the status signal generating circuits. The display device is electrically connected to the micro-controller. The status signals are processed by the micro-controller, and the processed status signals are directly transmitted to the display device for display without being processed by the central processing unit.

### FIELD OF THE INVENTION

The present invention relates to a status signal displaying system, and more particularly to a status signal displaying system for use in a motherboard.

### BACKGROUND OF THE INVENTION

For enhancing the performance of a computer system, the user may change the BIOS (basic input output system) settings of the computer system. For example, through the BIOS settings, the operating voltage or the operating frequency to be used in a control chip or a central processing unit on a motherboard is adjustable. For example, overdlocking is the process of forcing a computer component to run at a higher clock rate than it was designed or designated by the manufacturer; and dynamic voltage scaling to increase voltage is known as overvolting. Moreover, the performance of the computer system is also enhanced by adjusting the rotating speed of the fan of the computer system. Generally, the motherboard of the computer system is provided with a hardware monitor for realizing whether the computer system is operated at the operating voltage or the operating frequency that is selected by the user. The hardware monitor is usually implemented by a low pin count super I/O device.

FIG. 1 is a schematic functional block diagram illustrating a motherboard having a status detecting function according to the prior art. As shown in FIG. 1, a central processing unit (CPU) 110, a north bridge (NB) chip 120, a south bridge (SB) chip 130, a memory 140 and a graphic processing unit (GPU) 150 are mounted on the motherboard 110. The north bridge chip 120 is electrically connected to the central processing unit 110, the south bridge chip 130, the memory 140 and the graphic processing unit 150.

Take the central processing unit 110 for example. The core voltage Vcore of the central processing unit 110 is supplied by a voltage regulating module (VRM) 104. The core clock CLKcore of the central processing unit 110 is generated by a clock generator 106. Via the BIOS setup menu, the user may control the voltage regulating module 104 to output an adjusted core voltage Vcore. Likewise, via the BIOS setup menu, the user may control the clock generator 106 to generate an adjusted core clock CLKcore. Alternatively, the manufacturer of the motherboard may provide a specified voltage and frequency adjustable application program (AP) for adjusting the core voltage Vcore and the core clock CLKcore. Generally, the clock generator 106 also generates a core clock reference voltage Vr, which is in direct proportion to the frequency of the core clock CLKcore. In other words, as the frequency of the core clock CLKcore is increased, the core clock reference voltage Vr is increased. In addition, a CPU fan 102 is used to dissipate the heat generated by the central processing unit 110. In a case that the central processing unit 110 is operated at a heavy load, the rotating speed of the CPU fan 102 is increased to enhance the heat-dissipating efficiency. Whereas, in a case that the CPU fan 102 is operated at a light load, the rotating speed of the CPU fan 102 is decreased. In addition, the CPU fan 102 may output a rotating speed signal Rfan to indicate the actual rotating speed of the CPU fan 102. A temperature detecting unit 108 (e.g. a thermistor) is arranged beside the central processing unit 110 for detecting the temperature of the central processing unit 110 and outputting a CPU temperature signal Tcpu.

In addition, a hardware monitor 160 is disposed on the motherboard 100. The hardware monitor 160 is controlled by the south bridge chip 130. The hardware monitor 160 is also electrically connected to the voltage regulating module 104, the clock generator 106, the CPU fan 102 and the temperature detecting unit 108. After the core voltage Vcore, the core clock reference voltage Vr, the rotating speed signal Rfan and the CPU temperature signal Tcpu are received by the hardware monitor 160, the values of the actual core voltage, the core clock frequency, the rotating speed of the CPU fan and the CPU temperature are provided to the central processing unit 110 and displayed on the computer screen.

Similarly, the messages including the operating voltage, the operating frequency, the operating temperature and the fan's rotating speed of the north bridge chip 120, the south bridge chip 130, the memory 140 and the graphic processing unit 150 may also be provided to the hardware monitor 160. These messages are provided to the central processing unit 110 and displayed on the computer screen. In this context, the signals received by the hardware monitor 160 are referred as status signals.

Generally, for realizing the operating status of the computer system, an operating status application program needs to be executed under the operating system. During the operating status application program is executed, the central processing unit 110 issues a request to the hardware monitor 160 through the north bridge chip 120 and the south bridge chip 130. When the request is received by the hardware monitor 160, the hardware monitor 160 responds to the central processing unit 110 by issuing the statuses signals to the central processing unit 110. After the central processing unit 110 are received by the central processing unit 110, the status signals indicative of the operating conditions of the computer system are displayed on the computer screen.

Since the statuses signals to the central processing unit 110 needs to be transmitted to the central processing unit and the execution of the operating status application program is necessary, the overall performance of the computer system is impaired. If the operating status of the computer system is continuously monitored, the overall performance of the computer system may be largely deteriorated.

### SUMMARY OF THE INVENTION

The present invention relates to a status signal displaying system for realizing the operating status of a computer system without impairing the performance of the computer system.

In an embodiment, the present invention provides a status signal displaying system. The status signal displaying system includes a motherboard, a micro-controller and a display device. The motherboard includes a central processing unit and a plurality of status signal generating circuits for generating status signals. The micro-controller is electrically connected to the status signal generating circuits. The display device is electrically connected to the micro-controller. The status signals are processed by the micro-controller, and the status signals are directly transmitted to the display device for display without being processed by the central processing unit.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a motherboard having a status detecting function according to the prior art;

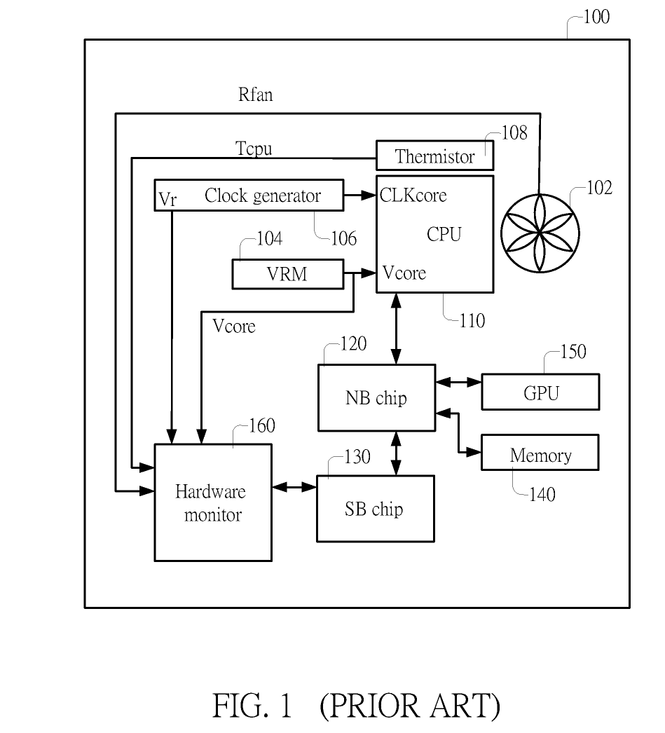

FIG. 2 is a schematic functional block diagram illustrating a motherboard having a status detecting function according to a first preferred embodiment of the present invention; and

FIG. 3 is a schematic functional block diagram illustrating a motherboard having a status detecting function according to a second preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

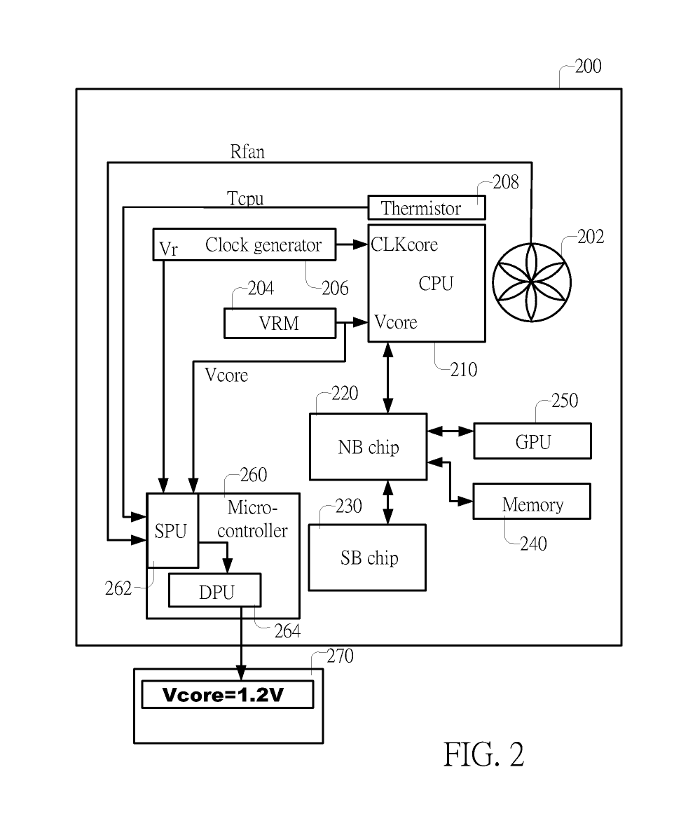

FIG. 2 is a schematic functional block diagram illustrating a motherboard having a status detecting function according to a first preferred embodiment of the present invention. As shown in FIG. 2, a central processing unit (CPU) 210, a north bridge (NB) chip 220, a south bridge (SB) chip 230, a memory 240 and a graphic processing unit (GPU) 250 are mounted on the motherboard 210. The north bridge chip 220 is electrically connected to the central processing unit 210, the south bridge chip 230, the memory 240 and the graphic processing unit 250.

Take the central processing unit 210 for example. The core voltage Vcore of the central processing unit 210 is supplied by a voltage regulating module (VRM) 204. The core clock CLKcore of the central processing unit 210 is generated by a clock generator 206. Via the BIOS setup menu, the user may control the voltage regulating module 204 to output an adjusted core voltage Vcore. Likewise, via the BIOS setup menu, the user may control the clock generator 206 to generate an adjusted core clock CLKcore. Alternatively, the manufacturer of the motherboard may provide a specified voltage and frequency adjustable application program (AP) for adjusting the core voltage Vcore and the core clock CLKcore. enerally, the clock generator 206 also generates a core clock reference voltage Vr, which is in direct proportion to the frequency of the core clock CLKcore. In other words, as the frequency of the core clock CLKcore is increased, the core clock reference voltage Vr is increased; and vice versa.

In addition, a CPU fan 202 is used to dissipate the heat generated by the central processing unit 210. In a case that the central processing unit 210 is operated at a heavy load, the rotating speed of the CPU fan 202 is increased to enhance the heat-dissipating efficiency. Whereas, in a case that the CPU fan 202 is operated at a light load, the rotating speed of the CPU fan 202 is decreased. In addition, the CPU fan 202 may output a rotating speed signal Rfan to indicate the actual rotating speed of the CPU fan 202. A temperature detecting unit 208 (e.g. a thermistor) is arranged beside the central processing unit 210 for detecting the temperature of the central processing unit 210 and outputting a CPU temperature signal Tcpu.

Moreover, a micro-controller 260 is further provided on the motherboard 200. The micro-controller 260 comprises a signal processing unit (SPU) 262 and a display processing unit (DPU) 264. The signal processing unit 262 is electrically connected to the voltage regulating module 204, the clock generator 206, the CPU fan 202 and the temperature detecting unit 208. After the messages including core voltage Vcore, the core clock reference voltage Vr, the rotating speed signal Rfan and the CPU temperature signal Tcpu are received by the signal processing unit 262, these messages (i.e. status signals) are converted into display signals by the signal processing unit 262. The display processing unit 264 is electrically connected to a small-sized display device 270. The display signals are received by the display processing unit 264 and then transmitted to the small-sized display device 270.

In this embodiment, the micro-controller 260 can simultaneously receive the status signals that are outputted from the central processing unit 210, the north bridge chip 220, the south bridge chip 230, the memory 240 and the graphic processing unit 250. These status signals are generated by detecting the operating statuses of the central processing unit 210, the north bridge chip 220, the south bridge chip 230, the memory 240 and the graphic processing unit 250. Examples of the status signals include the rotating speed signal and temperature signal of corresponding components. It is preferred that the display signals are periodically displayed on the small-sized display device 270 to notify the user of the operating condition of all components. For example, if a message of “Vcore=1.2V” is displayed on the small-sized display device 270, the user can realize the core voltage of the computer system according to this message.

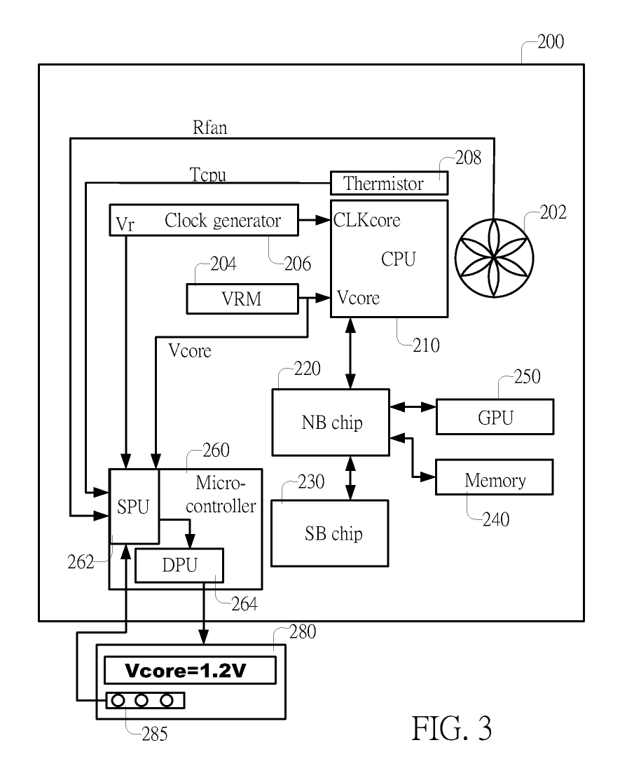

FIG. 3 is a schematic functional block diagram illustrating a motherboard having a status detecting function according to a second preferred embodiment of the present invention. The central processing unit 210, the north bridge chip 220, the south bridge chip 230, the memory 240, the graphic processing unit 250, the micro-controller 260, the CPU fan 202, the clock generator 206 and the temperature detecting unit 208 included in FIG. 3 are identical to those shown in FIG. 2, and are not redundantly described herein. In comparison with the first preferred embodiment, the display processing unit 264 of the micro-controller 260 is electrically connected to a small-sized display device 280 with several control buttons 285. By triggering one or more of the control buttons 285, the micro-controller 260 will outputs operating statuses of corresponding components to the small-sized display device 280.

From the above description, since the status signals are processed by the micro-controller but the micro-controller is not controlled by the central processing unit, the performance of the computer system is not impaired. That is, the status signal displaying system of the present invention is capable of realizing the operating status of a computer system without impairing the performance of the computer system. In the above embodiments, the micro-controller is disposed on the motherboard but the small-sized display device is disposed outside the motherboard. It is noted that, however, those skilled in the art will readily observe that the locations of the micro-controller and the small-sized display device are not restricted. For example, both of the micro-controller and the small-sized display device may be disposed on the motherboard or outside the motherboard.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A status signal displaying system comprising:
a motherboard comprising a central processing unit and a plurality of status signal generating circuits for generating status signals;
a micro-controller electrically connected to the status signal generating circuits; and
a display device electrically connected to the micro-controller, wherein the status signals are processed by the micro-controller, and the status signals are directly transmitted to the display device for display without being processed by the central processing unit.

2. The status signal displaying system according to claim 1 wherein the micro-controller comprises:
a signal processing unit for converting the status signals into corresponding display signals; and
a display processing unit for receiving the display signals and outputting the display signals to the display device for display.

3. The status signal displaying system according to claim 1 wherein the status signals are periodically displayed on the display device.

4. The status signal displaying system according to claim 1 wherein the display device further comprises at least one control button, and by triggering the control button, the micro-controller outputs a corresponding status signal to the display device for display.

5. The status signal displaying system according to claim 1 wherein the status signal includes a core voltage of the central processing unit.

6. The status signal displaying system according to claim 1 wherein the status signals include a core clock reference voltage, which is in direct proportion to a frequency of a core clock of the central processing unit.

7. The status signal displaying system according to claim 1 wherein the status signals include a fan's rotating speed signal.

8. The status signal displaying system according to claim 1 wherein the status signals include a temperature signal that is outputted from the temperature detecting unit.

9. The status signal displaying system according to claim 1 wherein the micro-controller and the display device are both disposed outside the motherboard.

10. The status signal displaying system according to claim 1 wherein the micro-controller is disposed on the motherboard but the display device is disposed outside the motherboard.

11. The status signal displaying system according to claim 1 wherein the micro-controller and the display device are both disposed on the motherboard.

12. The status signal displaying system according to claim 1 wherein the motherboard further comprises a north bridge chip, a south bridge chip, a memory and a graphic processing unit, and the status signal generating circuits generate the status signals by detecting the north bridge chip, the south bridge chip, the memory or the graphic processing unit.
